(19) United States
(12) Patent Application Publication
(10) Pub. No.: US 2004/0126480 A1
(43) Pub. Date: Jul. 1, 2004

(54) Food process

(75) Inventors: Hubertus Leonardus Lelieveld, Bilthoven (NL); Martina Adriana Mostert, Rotterdam (NL); Hans Hoogland, Vlaardingen (NL)

Correspondence Address: UNILEVER, PATENT DEPARTMENT, 45 RIVER ROAD, EDGEWATER, NJ, 07020, US

(73) Assignee: Unilever Bestfoods North America

(21) Appl. No.: 10/329,841

(22) Filed: Dec. 26, 2002

(51) Int. Cl. A23L 1/00

(52) U.S. Cl. 426/665

(57) ABSTRACT

A new way to improve utilization by institutions of food service items. Institutions which provide to consumers ready-to-consume foods can expedite their service by using foods which have been subject, in whole or in part, to high pressure preservation. Use of high pressure preservation avoids or minimizes the need for refrigeration of the food, thus reducing costs, sparing resources and lowering space requirements. Likewise, the need for microwave equipment is decreased or eliminated. Elimination or decreasing refrigeration requirements decreases preparation and serving time since the time required for thawing the product is reduced or eliminated.

### BACKGROUND OF THE INVENTION

During the last decade, food service began to enjoy greater significance within the food industry. In the midst of increasingly complex lives, and with the amount of time available for preparation of meals steadily decreasing, consumers found the convenience of eating in restaurants or of bringing home ready-to-consume foods difficult to resist. And, just as lack of time often motivated a consumer's visit to a local restaurant, especially to a fast food restaurant, time pressures likewise increased the need for expeditious service at the restaurant.

Proprietors of restaurants have many concerns in addition to the speed with which food is served. The food industry and the public receive periodic reminders of how important it is that foods which are served in restaurants and elsewhere are appropriately preserved. Such reminders can be found in the form of press reports of occasional outbreaks of illness caused by food-borne pathogens.

Foods which are susceptible to contamination by pathogens are often preserved by refrigeration at freezing, or sometimes higher, temperatures. Use of refrigeration, especially freezers, is however, a very expensive proposition. The equipment is expensive, requires valuable energy, and takes up considerable space. Perhaps more significantly, preparation for consumption of food which has been frozen takes valuable time and effort, thereby delaying serving of the meal to the consumers and increasing the cost. Thawing of the product may take a long period of time during which contamination may occur. When a quick thaw is attempted, a microwave is required and much additional energy is necessary to melt frozen product. Moreover, heating of a frozen product in a microwave introduces an additional potential source of consumer dissatisfaction, to which any consumer who has been served a supposedly-hot entrée which is warm on the surface but cold in the interior will attest. Likewise, heating of a frozen product can be done to excess, resulting in a product which is dried out.

Refrigeration is not the only technical solution which has been employed for preservation of certain foods in certain situations. Various other solutions have been proposed.

Agterof et al., U.S. Pat. No. 6,033,717 (also see EP 918 472) to Unilever Patent Holdings is directed to a continuous ultra high pressure preservation process said to be suitable for processing foods. The substance to be preserved is conducted in a steady flow through an open narrow tube while the pressure difference between the entrance to and the exit from the tube is maintained at 100 MPa or more.

Lelieveld et al., WO 00/25609 (Unilever) is directed to a method of preserving a food product by applying a high pressure wherein food is forced through a treatment system having an entrance and exit with a pressure difference of at least 10 MPa. The product is subjected to a varying magnetic and/or electric field.

Boldon, U.S. Pat. No. 6,391,366 discloses ready to cook, frozen, farinaceous batters, plastic at frozen temperatures, which can be scooped to form cooked goods, especially for food service preparation of baked muffins. In the “Background of the Invention,” various aspects of the baking of flour based batters are discussed. It is mentioned that complete dry mixes, which require the addition only of water or milk, are especially popular in food service applications inasmuch as the labor and skill needed to prepare large quantities of food are minimized.

Boldon indicates that batters which are already prepared and ready for use would be desirable, but that there are a number of problems attendant to this form of product, such as need to use soon after preparation to avoid loss of leavening and the need for refrigeration to avoid microbiological spoilage.

Since both spoilage and leaving reactions are temperature dependent, greater storage stability is more easily obtained with refrigerated batters, Boldon explains. However, such refrigerated batters are said to require coating or sequestering the one or more of the leavening ingredients and protection against microbiological spoilage such as heat treatment or ultra high pressure sterilization.

Also known, according to Boldon, are unaerated frozen batters for baked goods for foodservice that require up to 36 hours of refrigerated temperature thawing prior to use, which must be used within a short period of time. These can be refrozen, but use after re-freezing is said to suffer from inconsistent or poor baking properties.

Boldon's invention is said to provide further improvements in food services batters for baked goods, in particular complete batters that require no further addition of ingredients for further processing prior to baking. It is said that the batters can be stored for extended times without disabling loss of leavening. The Boldon complete batters are chemically leavened with quick acting leavening prior to freezing.

Garcia et al. U.S. Pat. No. 6,264,543 (assigned to USA represented by the Secretary of the Navy) is directed to a system and method to tenderize and sterilize meats. The meat is carried through a liquid and subjected to electromechanical transducers. Institutional and governmental buyers, as well as personnel in the armed forces, are mentioned in the “Background of the Invention.” The electromechanical transducers are oriented and controlled to project simultaneously converging shock waves of energy to and into the batch of meat.

High pressure sterilization is discussed in the Garcia et al. patent and is said to involve subjecting food to high pressure, typically hundreds to thousands time atmospheric pressure. Conventional apparatuses for high pressure sterilization are said to be large and the sterilization ability poor since the apparatus is incapable of performing successive sterilizations.

WO 99/29187 (Meyer) discloses methods for commercial sterilization of foods which involve preheating the food to from about 110 to 160° F. and thereafter pressurizing the food to 20,000 to 120,000 psi for a short period of time. It is said that sterilization can be achieved in a few minutes or less without exceeding the taste transition temperature of the food, thus retaining fresh flavor. It cites the disclosure in Clark et al., U.S. Pat. No. 5,232,726 of use of ultra high pressure homogenization to prolong the shelf life of orange juice. Sterilization of various foods by applying pressures of about 25,000 psi in Hirsch U.S. Pat. No. 5,593,714 is also mentioned.

Ting et al., U.S. Pat. No. 5,316,745 is directed to an ultra high pressure sterilizing apparatus wherein material to be sterilized is alternately pressurized and depressurized in a cylinder chamber comprising a plunger.

Wilson et al., U.S. Pat. No. 6,086,936 is directed to a method for sterilizing foods using both ultra high pressures and high temperatures.

Meyer U.S. Pat. No., 6,017,572 is directed to methods for achieving commercial sterilization of foods having a pH greater than or equal to 4.5 involving treatment of the food to two or more cycles of high heat, high pressure with a brief pause between cycles.

Kuratomi, U.S. Pat. No. 3,727,028 is directed to an ultra high pressure-temperature apparatus. High pressure is generated within the apparatus by urging pistons toward the object to be subjected to pressure.

Sotoyama et al., EP 1027835 (Moringa Milk) discloses a method for continuous heat sterilization of a liquid comprising a heating step and a step of continuously pressurizing the liquid with a high pressure pump.

Tomikawa et al., U.S. Pat. No. 5,588,357 is directed to a shock wave sterilizer for sterilizing a fluid medium such as food. An elastic container contains the food, a shock wave source is disposed to face the elastic container and a pressure transfer medium is interposed between the shock wave source and the elastic container.

Van Schepdaiel et al., WO 02/45528 (Ato, B.V. and Unilever N.V.) relates to a method of high pressure preservation of a food product or treatment of a pharmaceutical product in a pressure vessel. The method combines one or more pressure pulses subjected to a preheated product. FIGS. 11-12 illustrate a vessel which can be pressurized by driving a plunger.

As used herein, “high pressure preservation” (HPP) refers to subjecting the food to a pressure of at least 10 MPa, especially at least 100 MPa, more preferably at least 200 MPa and most preferably at least 300 MPa for a continuous period of at least one second. Thus, preservation by use of very short period (e.g., millisecond) shock waves is not in the purview of the invention. High pressure preservation includes, but is not limited to, high pressure sterilization.

As used herein, “ready-to-consume food” means a food which has received any cooking or other preparation normally undertaken imminently prior to consumption by consumers. The term “ready-to-consume foods” encompasses foods which require no cooking or other preparation at the point of consumption, e.g., breads and bread spreads (hereinafter “pre-prepared ready-to-consume foods”) and foods and ingredients which require cooking or other preparation of the food itself (as opposed to removal of packaging or simply readying the food for presentation to the consumer) at the point of consumption, such as batters, meals, meat, sauces, potatoes, pasta, vegetables and pizza (hereinafter “site-prepared ready-to-consume foods.”)

As used herein, “consumer” means an individual who ingests, or who is a potential ingester, of a food product.

As used herein, “consuming site” means a location in or around which consumers typically consume food products. Consuming sites include, but are not limited to, snack bars, restaurants, cafeterias, in-room eating in hospitals, room service in hotels, and catering halls. Consuming sites may be situated within what are traditionally not primarily consuming sites, e.g., a cafeteria in a supermarket or department store.

As used herein, “sterilization” means rendering micro-organisms, their spores and/or their enzymes harmless with respect to consumers and product quality.

As used herein, “unfinished food” is a food which is not in a form ready for retail sale to consumers.

“Fresh food” has not been subjected to high preservation temperatures or to freezing temperatures. Fresh food does not include canned food or frozen food.

### SUMMARY OF THE INVENTION

The invention is directed to the discovery of a new way to improve utilization by institutions of food service items. It has been discovered that institutions which provide to consumers ready-to-consume foods can expedite their service by using foods which have been subject, in whole or in part, to high pressure preservation. Use of high pressure preservation avoids or minimizes the need for refrigeration of the food, especially freezing of food, thus reducing costs, sparing resources and lowering space requirements. Likewise, the need for microwave equipment is decreased or eliminated. Elimination or decreasing refrigeration requirements decreases preparation and serving time since the time required for thawing the product is reduced or eliminated.

The invention finds particular use in avoiding the need to subject certain foods to freezing temperatures, i.e., less than 0° C. The invention is of special advantage in this respect since the energy required for freezing and, subsequently, for melting, the foods is quite large compared even to the energy required for chilling foods in typical refrigerators. The invention permits replacement of frozen foods with foods which have been subjected to high pressure preservation. Since food is either frozen, canned or fresh, and since temperature treatment of canned foods can impair food taste, the invention permits the food server to avoid the cost and time disadvantages of frozen, the taste disadvantages of canned and the short shelf life of fresh foods while enjoying the advantages of quicker preparation time and lower energy requirements.

The high pressure preservation treatment can be undertaken at the consuming site or at a location remote from the consuming site. The benefits of HPP will best be enjoyed when the treatment is undertaken either at a different time from food preparation at the consuming site or at a different location than the consuming site. Use of HPP avoids or minimizes refrigeration at the consumer site, at any storage sites, and during any required transport of the product. The HPP may be computer controlled. HPP can be applied to the whole food or to one or more ingredients thereof.

According to one embodiment of the invention, the HPP treated food is one which requires preparation, for example, cooking, mixing, etc. prior to being dispensed to the consumer. However, the invention may also be used for ready-to-consume foods which do not require such preparation. The invention finds its best use where food is to be dispensed to consumers at consuming sites. However, it is even useful where site-prepared ready-to-consume foods are dispensed to consumers at sites other than consuming sites.

As will be discussed further below, where the nature of the food permits, the pressure may be imposed in a continuous fashion, e.g., by pumping the food through an orifice having a restricted size such that a pressure difference between the entrance and the exit is maintained at 100 MPa or more. Typically this will be accomplished by pumping the food through a tube having an orifice at the exit end.

The pressure may be imposed directly on the food, such as by the method just described rather than through a medium. However, imposition of pressure on the food through a medium such as a liquid or a gas is not excluded. In the former case (liquid medium), the food may be placed in the liquid and the pressure imposed directly on the liquid and thence indirectly on the food. In some cases the medium may also be a food and so a liquid, for example, may serve the dual roles of a medium for imposition of pressure on a food contained therewithin and also as the food itself which is preserved.

Pistons are oft-employed in high pressure preservation. It will be appreciated from the foregoing, then, that among the alternative ways to impose pressure on the food would be both the use of pistons directly applied to the food as well as pistons applied to a liquid into which the food has been placed.

Any machinery capable of industrial high pressure food sterilization or ultra-high pressure food sterilization can be used.

It may be desirable in certain circumstances to subject the food to elevated temperatures during the HPP process. In a preferred embodiment the product is pre-heated to a pre-determined temperature before ultra-high pressure is applied. This pre-heating is typically done at a temperature of from 40 to 100°C., and is related to the pressure that is applied in the following steps. This pre-heating can be carried out outside the pressure vessel. It is highly preferred that the high pressure vessel is preheated to the same or higher temperature as the product to be preserved, to minimize heat loss.

In a further preferred embodiment, this pre heating is followed by pressurizing to ultra high pressure. The ultra high pressure is preferably from 500 MPa to 1000 MPa, more preferred 600 MPa to 800 MPa. Preferably the pressure is kept as low as possible for obtaining sterilization in view of the costs involved in increasing the pressure. The application of ultra high pressure will lead to instantaneous increase of temperature due to adiabatic heating. Subsequently the product is preferably decompressed, thereby returning to a temperature which is about the initial pre-pressurized temperature.

Preferably, the invention is utilized with respect to meals and meal components packed in sealed film (such as polypropylene) subjected to high pressure or to high pressure in combination with heat. The heat utilized can be much less than is used for thermal sterilization. For example, the meal may be on a tray, ready for consumption, or a bulk food such a macaroni and cheese or bacon, with or without sauces, suitable for placing on plates, and serving.

For a more complete understanding of the above and other features and advantages of the invention, reference should be made to the following detailed description of preferred embodiments and the accompanying drawings.

### BRIEF DESCRIPTION OF THE DRAWINGS

FIG. 1 shows a schematic view of high pressure preservation equipment with which the high pressure preservation step of the invention can be carried out.

FIG. 2 shows a schematic view of alternative equipment with which the high pressure preservation step of invention can be carried out. c is a tube with a length L and an inner diameter d. a is a storage container connected to the entrance of the tube via a pressure unit b. At d the open orifice of the tube is situated.

### DETAILED DESCRIPTION OF THE INVENTION

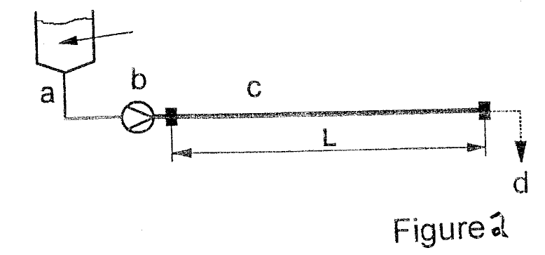

HPP treatment which is continuous, batch or semi-continuous can be employed, although, generally, continuous processing would be preferred where the nature of the food and the available HPP equipment makes this possible. In accordance with the continuous high pressure preservation embodiment, the preservation may be conducted by feeding the substance from the storage container a to the entrance of the tube via a pressure unit b and passing it through the tube to the exit at the right hand side (FIG. 2). However, any machinery capable of industrial high pressure food sterilization or ultra-high pressure food sterilization can be used. Such machinery is, for example, available from Avure Technology Inc. of Seattle, Wash., Flow International Corp., Kobe Steel, and Engineered Pressure Systems (Mass, US and Belgium).

In a preferred embodiment, the high pressure process is carried out under such conditions that leakage of heat from the product to the surrounding material is prevented. In a preferred aspect the invention relates to an embodiment wherein under high pressure either,

a) the temperature of the product and the surface temperature of the material surrounding the product are the same or

b) the surface temperature is higher than the product temperature or

c) the surface temperature is at most 10° C., more preferred at most 5° C. lower than the product temperature.

For the purpose of the invention the material surrounding the product includes, for example, the pressurization liquid which is surrounding the product, a vessel wall which is in close vicinity or even in contact with the product, and a container material which is in the close vicinity or even in contact with the product. The most common surrounding material is water.

Preferably the container is made from a flexible material, i.e., one which can be reformed without breaking such as plastic bags. It has been found that the container (solid or flexible) preferably has a certain wall thickness to optimize the preservation conditions and minimize heat leakage.

The thickness influences the time the increased temperature needs to be maintained. Therefore in a preferred embodiment, the container has a wall with a thickness of at least 5 mm, preferably from 6 to 20 mm, more preferred 6 to 10 mm.

To achieve this, the container is preferably made from a material showing a temperature rise caused by high pressure treatment, which is at least similar, preferably higher, than the temperature rise of the product. As explained above, ultra-high pressure causes an instantaneous temperature rise in the compressed material. The amount of the increase of temperature differs for each individual material. To prevent heat leakage and the development of a temperature difference between the product to be preserved and the container in which it is held during high pressure preservation, the temperature rise in both is preferably similar. Similar in the context of the invention is defined as showing a difference in temperature rise of at most 10° C., preferably at most 5° C., more preferably at most 1°C., even more preferred at most 0° C.

It will be appreciated that materials which show a larger temperature rise than the product to be preserved are also suitable container materials but as the resulting increased temperatures may damage the product, materials which show a temperature increase of more than 20° C. compared to the temperature increase of the product under compression, are not preferred.

The product is preferably preserved in pack because otherwise the preserved product requires costly aseptic packaging after the high pressure treatment.

In the continuous embodiment, preservation is carried out by maintenance of a high kinematic pressure in a tube which is relatively narrow and open at the exit end, which kinematic pressure in at least a part of the tube is sufficiently high that a microbiologically contaminated fluid during its flowing through the tube becomes decontaminated while the flow proceeds at a high enough rate to make the process economically feasible.

In this continuous embodiment, the invention encompasses a step for decreasing the viability of microorganisms and/or the activity of enzymes in a contaminated substance by exerting a high pressure on the substance, characterized in that the substance is conducted in a steady flow through a tube, while the pressure difference between the entrance end and the exit end of the tube is maintained at 100 MPa or more. This presents a fully continuous UHP (ultra high pressure) preservation process. In the process of the invention, this step is combined with use of the decontaminated substance in food service, preferably resulting in one or more of the aforementioned advantages.

The continuous HPP aspect of the invention can be applied to all types of fluid foods which need a decontamination treatment, provided they have a consistency which allows a sufficiently quick passage through the necessarily small tubes employed with the invention. Such products include spreads, mayonnaise, dressings, milk, tea and even heat sensitive products as ice-cream and soft cheese. The invention is particularly suitable for substances which tolerate only gentle treatments. The treated substance may be a final food product ready for consumption by the consumer.

In order to maintain a pressure of at least 100 MPa between the entrance and the exit of the tube, a proper balance should be found between on the one side the diameter and length of the tube and on the other side the given viscosity and the desired flow of the product to be treated. The minimum volume V of the tube results from the formula:

V=t*f,

where t is the minimum residence time for effective decontamination and f is the desired flow. The residence time can be adjusted without changing the narrow tube dimensions by inserting a chamber at the upstream end of the narrow tube, between the exit of the pressure device and the entrance of the narrow tube. With such chamber the ultra high pressure volume is increased and consequently the residence time of the fluid. Because of its resistance against high pressures, such chamber preferably is a tube too, which diameter is greater than the narrow tube diameter so that pressure drop and flow are not substantially influenced by the presence of the chamber. Preferably such chamber has a diameter which is at least 5 times greater than the narrow tube diameter. The following description of a tube is not applicable to this residence chamber, but rather to the attached narrow tube. Unless it is indicated otherwise, the term tube is used for the narrow tube.

In the context of the present description a tube is considered to be a vessel having a round transverse cross section and with two openings at both ends of the vessel where the length of the vessel is at least ten times the width of the vessel. Generally, the ratio of the length and the average diameter of a tube suitable for the invention is at least 1000, preferably at least 10,000. Generally this means a diameter of only several millimeters and a length of at least several meters. The optimum dimensions can be easily found by some calculations and experimentation. Good results can be obtained with a tube having a length of only 200 m and an internal diameter of 10 mm. With said open tubes an output per hour of about 50 liter product having an oily viscosity can be realized by exerting a pressure of 1000 MPa. The high flows needed in practice are realized by combining into bundles large numbers of parallel tubes. See also Table I of WO 97/43914, the full disclosure of which published application is incorporated by reference herein, for examples of suitable tube dimensions in relation to given substance viscosity and exerted pressure.

The pressure within the tube of the CHPP embodiment (where C=continuous) should be at least 100 MPa, but pressures of at least 300 MPa are preferred. Generally higher pressures allow shorter decontamination times.

It is anticipated that the ultra high pressures needed for working the continuous embodiment of the invention can be withstood best by tubes with relatively narrow diameters: 10 mm or less is preferred. Special reinforcement is not necessary. The continuous preservation device does not need the very thick walls of prior art equipment.

The tube may be placed in any position, but preferably a compact form such as a coil is chosen. Tubes having a circular intersection are most advantageous in resisting high pressures, but other forms of intersections are not excluded. Glass and stainless steel, substances which are compatible with food, are preferred tube materials.

For the pressure device or unit a choice can be made from the devices found on the market which are meant for pumping fluids under ultra high pressures.

In order that the exerted pressure has a sufficient effect on the micro-organisms, the residence time of the fluid in the tube at the ultra high pressures should be a least 1 second. Generally, longer residence times are needed when the pressure is lower than 350 MPa. Preferably the residence time is at least 2 minutes, more preferably at least 5 minutes and still more preferably at least 10 minutes.

The continuous device operates with a permanently open orifice at the end of the tube. The effect is a pressure gradient along the whole length of the tube. Consequently the pressure in the tube is higher in upstream parts than in downstream parts of the tube, with the effect that decontamination takes place predominantly in the upstream part of the tube.

Operating the process at a temperature different from ambient temperature may be advantageous. When the temperature is lowered, the viscosity will increase which makes it possible to maintain the pressure at the desire level even when the fluid to be treated is not sufficiently viscous at ambient temperature. A temperature increase will cause a lowered viscosity and an advantageous increase of the flow will result. Such increase will meet the obvious limitation that the substance to be treated needs a minimum residence time in the tube.

The CHPP method, where applicable, enjoys the advantage of simplicity which not only can contribute to economy but also to process reliability.

It will be apparent that the CHPP method described herein will not be appropriate for every type of ready-to-consume foods served in institutions. Other HPP methods known in the art, such as the other HPP methods described in the background of the invention, may be suitable. One of ordinary skill will be able readily to choose an HPP method suitable to a particular food.

In addition to minimizing refrigeration, the HPP method allows the decontamination of food products where the use of preserving ingredients, a low pH or the use of heating is undesirable. Nevertheless the method may be used in combination with one or more other preservation methods. When combining methods, often much less severe over-all conditions will suffice for attaining the required decontamination degree.

The HPP-treated food will generally be transported from a food manufacturing site to the site where it will be presented to consumers. This will often be a “consuming site,” i.e., a location in or around which consumers typically consume food products. Examples include, but are not limited to, snack bars, restaurants, cafeterias, in-room service of food in hospitals and hotels, eating halls in universities, other schools and other institutions such as the military (mess halls), and catering halls. Consuming sites may be situated within what are traditionally not primarily consuming sites, e.g., a cafeteria in a supermarket, department store, school or hospital. Restaurants include all manner of restaurants, such as fast food restaurants, luxury restaurants, etc. In accordance with the invention, the products can generally be transported at ambient temperatures, avoiding the considerable costs and energy resources needed for frozen transport.

The invention is further illustrated by the following example:

### EXAMPLE 1

### (Prophetic)

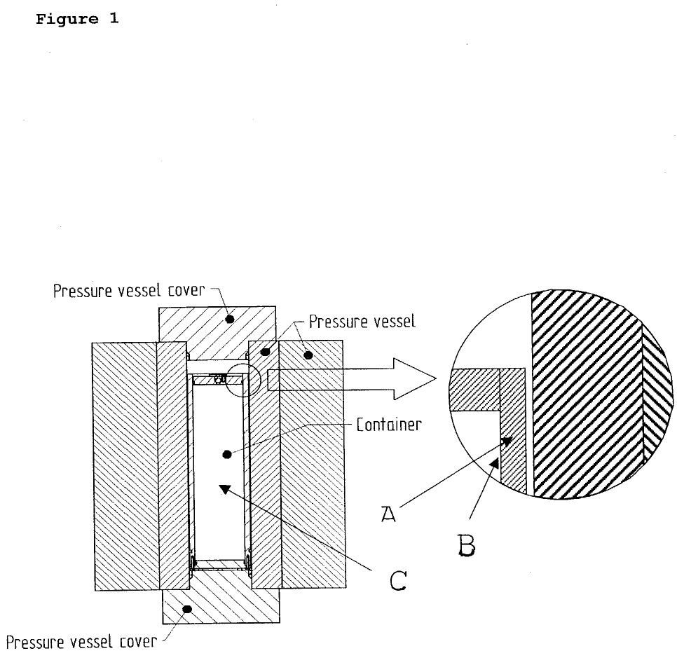

A container is made from polyoxymethylene according to FIG. 1 and placed in an ultra high pressure vessel made by EPSI (Belgium). A separate container made of polyoxymethylene is filled with an emulsion comprising 10 wt. % soy oil in water. This container is preheated to a temperature of 90° C. and placed inside the high pressure vessel which is preheated to 90° C. in a pre-heating step.

Subsequently ultra high pressure is installed to a pressure of at most 700 MPa (7000 bar) and the temperature inside the vessel is determined at three places. The maximum pressure is maintained for 60 seconds and then the pressure is released again.

Temperatures are recorded at the center of the container wall (location A), at the interface between container and product (location B) and at the center of the product (location C).

### EXAMPLE 2

### (Prophetic)

The apparatus of FIG. 1 is used to subject a bulk macaroni and cheese meal, present in a polyethylene bag, to pressures of from 500 to 700 MPa. The thus-preserved meal is stored for two weeks at room temperature and transported to the kitchen of a restaurant without being subjected to temperatures below 1° C. The meal is removed from the bag, heated, served and consumed. A small sample is taken for microbiological analysis and it is found to be commercially sterile.

### EXAMPLE 3

### (Prophetic)

In 1000 ml of glycerol, 100 cells per ml of the yeast Saccharomyces cerevisiae are dispersed in a cookie dough, at a cookie dough manufacturing facility. The dispersion, in which a natural contamination condition is emulated, is conducted through a tube with a length of 25 m and a diameter of 1 mm with a pressure of 300 MPa at the entrance of the tube. The residence time in the tube is 60 seconds and the temperature is ambient temperature, 21° C. The substance collected at the end of the tube is assayed for contamination, but no detectable amount of yeast cells is established. The dough is transported without any refrigeration to the kitchen of a restaurant where it is stored for 10 days at ambient temperature (mainly 78° F.). After 10 days of storage, it is without need for any thawing step. It will be appreciated that the invention eliminates or decreases the need for refrigeration of the cookie dough or for any thawing step. The cookies are baked in the kitchen of the restaurant and served at the restaurant to customers. FIG. 2 shows a schematic view of equipment with which the high pressure preservation step of Example 3 may be attempted. c is a tube with a length L and an inner diameter d. a is a storage container connected to the entrance of the tube via a pressure unit b. At d the open orifice of the tube is situated.

It should be understood, of course, that the specific forms of the invention herein illustrated and described are intended to be representative only as certain changes may be made therein without departing from the clear teachings of the disclosure. Accordingly, reference should be made to the following appended claims in determining the full scope of the invention.

What is claimed is:

1. A process for preparing and dispensing a ready-to-consume food comprising:
(a) subjecting a food or one or more of its ingredients to high pressure preservation treatment at a treatment site;
(b) providing the food to a consuming site;
(c) preparing the food for consumption at the consuming site to form a site-prepared ready-to-consume food, and
(d) dispensing said site prepared ready-to-consume food to a consumer at said consuming site.

2. The process according to claim 1 wherein said food is dispensed to the consumer by selling it.

3. The process according to claim 1 wherein the consuming site is selected from the group consisting of snack bars, restaurants, cafeterias, catering halls, eating halls, and in room service of food in hotels and hospitals.

4. The process according to claim 1 wherein said treated food is not refrigerated subsequent to manufacture and prior to preparing the food for imminent consumption.

5. A process for dispensing a ready-to-consume food comprising:
(a) dispensing a ready-to-consume food to a consumer at a consuming site, wherein the ready-to-consume food or one or more of its ingredients has been subjected to high pressure preservation.

6. The process according to claim 5 wherein said food is dispensed to the consumer by selling it.

7. The process according to claim 5 wherein the consuming site is selected from the group consisting of snack bars, restaurants, cafeterias, catering halls, eating halls, and in room service of food in hotels and hospitals.

8. The process according to claim 5 wherein said treated food is not refrigerated after manufacture and prior to preparing the food for imminent consumption.

9. The process according to claim 1 further comprising transporting at ambient temperature said high pressure preservation treated food from said treatment site to said consuming site.

10. The process according to claim 9 wherein said high pressure preservation treated food is transported at ambient temperature a distance of at least 10 miles.

11. The process according to claim 10 wherein said high pressure preservation treated food is transported at ambient temperature a distance of at least 100 miles.

12. A process for preparing and dispensing an unfinished food for food service use, comprising:
I. A) subjecting the unfinished food or one or more of its ingredients to high pressure preservation, or
I. B) incorporating one or more ingredients which have been subjected to high pressure preservation into the unfinished food, or
I. C) selecting an unfinished food which has been subjected to high pressure preservation, and
II. providing said unfinished food to a site suitable for dispensing said unfinished food to consumers.

13. The process according to claim 12 wherein said unfinished food is transported at ambient temperature to said site suitable for dispensing.

14. The process according to claim 13 wherein said unfinished food is transported at ambient temperature at least 10 miles to said site suitable for dispensing.

15. A process for dispensing a food comprising:
(a) preparing for consumption a food which has been subjected to high pressure preservation, or which incorporates ingredients which have been subjected to high pressure preservation, and dispensing such site-prepared ready-to-consume food to consumers.

16. The process according to claim 15 wherein said site-prepared ready-to-consume food is dispensed to consumers by selling it.

17. The process according to claim 15 wherein said site-prepared ready-to-consume food is sold to the consumer at a consuming site.

18. The process according to claim 15 wherein preparing for consumption includes cooking the high pressure preserved food.

19. The process according to claim 17 wherein the consuming site is selected from the group consisting of snack bars, restaurants, cafeterias, catering halls, eating halls, and in room service of food in hotels and hospitals.
